(19) United States
(12) Patent Application Publication
(10) Pub. No.: US 2023/0015924 A1
(43) Pub. Date: Jan. 19, 2023

(54) ARTIFICIAL INTELLIGENCE TRAVEL POLICY ADVISOR

(71) Applicant: Onriva LLC, Foster City, CA (US)

(72) Inventors: Vajid H. Jafri, Redwood Shores, CA (US); Michael Joseph d'Almada-Remedios, Discovery Bay, CA (US); Hassan J. Abbas, Brisbane, CA (US)

(21) Appl. No.: 17/377,034

(22) Filed: Jul. 15, 2021

(51) Int. Cl. G06Q 10/02; G06Q 30/00; G06Q 50/14

(52) U.S. Cl. CPC G06Q 10/02; G06Q 30/018; G06Q 50/14

(57) ABSTRACT

A method to form the travel policy for an organization can include using feedback from a user selecting travel reservations annotated with the travel policy to continuously modify the travel policy. The travel policy can be improved to provide the organization with a control of the travel expenditures, together with an advanced knowledge of the travel reservations of the users. In addition, the travel policy can give the users the freedom to select the travel reservations that are most suitable to the users and also acceptable by the corporation.

### BACKGROUND

Companies can establish travel policies for controlling travel related expenditures or for ensuring uniform travel services. For example, high level management can be permitted to travel in first class or business class, while regular employees are restricted to coach class.

There are different approaches for companies to manage their employees' corporate travel expenditures, ranging from a very strict policy in which all restrictions and requirements of all aspects of travel reservations are specified, to a very flexible policy in which there is no restrictions or requirements with a company-first guideline. There are also policies that permit only booking through a specific travel agency. For example, a company can have a travel policy requiring the use of a designated travel agency, and travel booking, such as flights, hotels, and rental cars reservations, will only be allowed through the designated travel agency, with booking outside of the designated travel agency is not permitted, e.g., not eligible for reimbursement. There are also policies which in which the employees are allowed to book their corporate travel through their booking system of choice or through a designated travel agency. Finally, there are policies which specify guidelines regarding what travel related costs are permissible expenses. For example, a detailed policy can include specific restrictions and requirements, which are designed to prevent employees from booking items that are not allowed under the corporate travel policy.

Further, the travel policies can require pre-travel reporting of travel expenses and possible violations of travel policy, for example, to enforce corporate policy on a pre-travel basis. The travel policies can be designed to provide an automated expense reporting system.

FIGS. 1A and 1B illustrate prior art travel policies according to some embodiments. At one end of the spectrum, a travel policy 142A for an organization, such as for a corporation, can be highly rigid, and designed for maximum controllability, meaning all travel expenditures are spelled out, such as telling the users, e.g., the employees of the corporation, what to do when making travel reservation for the business of the corporation. The travel details are determined by the corporation, regardless of the employee preferences. The travel policy can determine what travel providers or suppliers to be used. For example, when an employee makes a flight reservation, the flight reservation must be made from a preferred airline, e.g., an airline having a pre-agreement with the corporation. Similarly, when an employee makes a car rental reservation, the car rental reservation has to be made from a preferred car rental company, e.g., a car rental company having a pre-agreement with the corporation. The travel policy can determine what travel classes can be booked for what levels of employees. For example, a mid-level management employee can make a business class reservation, while a regular employee can only fly economy class.

An advantage of the rigid travel policy is that the corporation can have control over the travel aspects of the employees, such as controlling the travel expenses and controlling the schedule and itineraries of the employees. A disadvantage of the rigid travel policy is the potential higher cost of travel expenditures, since the employees are not permitted to take advantages of any travel discount. Another disadvantage is the dissatisfaction of some employees, since the rigid travel policy does not allow the employees to choose any travel reservation that are not determined by the corporation.

At an opposite end of the spectrum, a travel policy 142B for an organization can be highly flexible, such as designed for maximum flexibility, meaning there are no restrictions on travel expenditures, as long as the travel expenditures are made under the consideration of doing the best for the company. The travel policy does not provide any travel detail, such as there are no preferred suppliers and no restriction on the amenity and travel classes.

An advantage of the flexible travel policy is that high cost saving can be achieved by the employees. In general, even though there can be some employees who can take advantage of the flexible policy to spend more on the travel reservation than they should, the large majority of the employees can be highly responsible, and thus can select the travel reservation that mostly suitable for both the employees and the corporation. A disadvantage of the flexible policy is the small number of employees who might abuse the flexible policy. Another disadvantage of the flexible policy is the lack of control over the employee actions, such as not knowing the travel details until the employees submit the travel reimbursement forms.

Thus, there is a need for an optimized travel policy for the corporation, in which the corporation can have control over the employee actions while the employees can have the freedom to choose travel reservations most suitable for their preferences.

### SUMMARY

In some embodiments, a method forms a travel policy for an organization. The method can include annotating travel search results with restrictions and requirements translated from the travel policy of the organization. The search results can be sorted or arranged based on the travel policy, such as based on the annotations, which represent the restrictions and requirements of the travel policy. Selections of the user about the travel reservations are analyzed to assess a degree of compliance with the travel policy. The selections and the analysis of the selections of the user are reported to the organization, such as to the department responsible to maintain and enforce the travel policy. The report to the organization can be used to tell the organization about the satisfaction of the user with the travel policy, such as to assist the organization in updating the travel policy to improve satisfaction of the user. The organization can modify the travel policy based on the report of the user selections and the analysis of the user selections. Machine learning or artificial intelligence can be used to provide suggestion to the organization regarding the travel policy modification based on the user selections.

In some embodiments, an Artificial Intelligence (AI) advisor, providing next generation travel advice, comprises a recommendation and policy engine that uses data and AI to learn and advise travelers on travel insights and choices for themselves and their company. The AI powered system is designed to empower travelers and companies to “do the right thing” by each other across a wide spectrum of control vs. empowerment bias, using flexible advice and enforcement combinations. This allows traditional companies to evolve seamlessly from traditional Travel Management Company (TMC) style travel policies to more progressive travel advice with marketplace empowerment.

### BRIEF DESCRIPTION OF THE DRAWINGS

FIGS. 1A and 1B illustrate prior art travel policies according to some embodiments.

FIG. 2 illustrates a schematic for a travel platform for generating a travel policy for an organization according to some embodiments.

FIGS. 3A through 3C illustrate flow charts for a process to form a travel policy according to some embodiments.

FIGS. 4A and 4B illustrate configurations for communication with the travel platform according to some embodiments.

FIG. 5 illustrates a flow chart for a travel policy formation according to some embodiments.

FIG. 6 illustrates a display of a graphical user interface according to some embodiments.

FIGS. 7A and 7B illustrate configurations of displayed search results according to some embodiments.

FIGS. 8A through 8D illustrate flow charts for search result displays according to some embodiments.

FIGS. 9A and 9B illustrate configurations of travel expenditures based on market conditions according to some embodiments.

FIGS. 10A through 10C illustrate flow charts for search result displays according to some embodiments.

FIG. 11 illustrates a process for reporting user actions according to some embodiments.

FIGS. 12A through 12C illustrate flow charts for reporting user actions according to some embodiments.

FIG. 13 illustrates a process for updating a travel policy according to some embodiments.

FIGS. 14A through 14C illustrate flow charts for updating a travel policy according to some embodiments.

FIGS. 15A and 15B illustrate computing environments according to some embodiments.

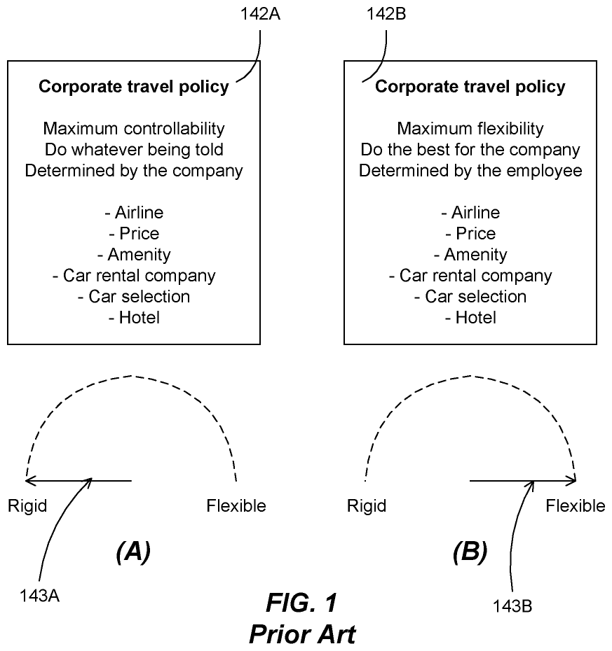

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

In some embodiments, the present invention discloses a travel policy of an organization, and methods to form the travel policy. The travel policy can be optimized to provide the organization with a control of the travel expenditures, together with an advanced knowledge of the travel reservations of the users associated with the organization, such as the employees of the corporation. In addition, the travel policy can give the employees the freedom to select the travel reservations that are most suitable to the employees and also acceptable by the corporation.

The method can include annotating travel search results with restrictions and requirements translated from the travel policy of the organization. The requirements and restrictions from the travel policy can set the policy for the travel related expenditures, including different requirements and restrictions for different associated users of the organization. The classification of travel expenditures can be based on the roles of the users, such as having different travel expenditure limits for officers, for high level managers, for low level managers, or for common employees. The classification of travel expenditures can be based on the salary levels of the users, with higher salary users having higher travel expenditure limits. The classification of travel expenditures can be based on the booking histories of the users, with users having a history of high compliance with the policy having higher travel expenditure limits as compared to users having a history of low compliance with the policy.

In some embodiments, the travel policy can include upper threshold limits, lower threshold limits, warning ranges, and allowed ranges of the travel related expenditures. The upper threshold limits can establish the maximum allowable expenses for different travel related expenditures. For example, air flight or hotel prices can have maximum limits, with different limits for different groups of users. In general, expenses above the upper threshold limits require approval from the organization.

The lower threshold limits can establish maximum automatic allowable expenses for different travel related expenditures. In general, expenses under the lower threshold limits are automatically approved, e.g., being pre-approved by the organization.

The warning ranges can establish ranges of expenditures that are allowable but with a warning from the organization. In general, expenses within the warning ranges require justifications from the user.

The allowable ranges can establish ranges of expenditures that are allowable by the organization. In general, expenses within the allowable ranges are automatically approved.

In some embodiments, the values for the upper and lower threshold limits, and the values for the warning and allowed ranges can be fixed values, e.g., the travel policy can specify numbers for the limits rand ranges. For example, an upper threshold limit for an air flight from Boston to San Francisco can be $2000, or an allowed range of meals is between $20 and $40.

In some embodiments, the values for the limits ranges can be determined by the market conditions, e.g., there is no fixed value specified by the travel policy. Instead, the limits and ranges can be calculated from the average values offered by the market. For example, during an emergency situation or during a highly popular event, the air fares can be significantly increased due to a large number of people travelling from or to the affected areas. The limits and ranges determined by the travel policy can be adjusted to conform to the changes in market valuations. Similarly, during a promotion period in which there is minimal people movement, air fares can be reduced, and the limits and ranges can also be adjusted.

The travel search results can be the results generated from a request for a travel reservation of a user associated with the organization, with the travel reservations made for the organization business. Each search result can include a candidate travel reservation, such as a flight itinerary meeting the departure and destination inputs from the user. Each search result can include an annotation, which can serve to notify the user of the travel policy. For example, the annotations can include a notice of compliance or a notice of non-compliance with the travel policy.

The non-compliance notices can include a non-booking notice, which indicates that the travel reservation is not allowable by the travel policy. The annotation for the non-booking notice can include an explanation from the organization, explaining the reasons for the non-bookable reservation, such as having too high a price, or an unsafe flight. The non-bookable reservation can also include a feedback field, for example, to allow the user to rebut the non-bookable decision of the organization. The feedback of the user can be reported to the organization for review, which can result in an improved travel policy, e.g., a travel policy that is suitable for both the organization and the users.

The non-compliance notices can include a bookable notice, which indicates that the travel reservation is allowed, but not recommended, by the travel policy. The annotation for the bookable, but not complied with the travel policy, reservation can include an explanation from the organization, explaining the reasons why the reservation does not comply with the travel policy, such as having a price that is considered not optimal from the point of view of the organization, or having a flight itinerary that having a long stop over. The bookable, but not complied, reservation can also include a justification field, for example, to allow the user to justify the reasons for selecting the non-compliance reservation. The justification can be optional, for example, if the non-compliance is minor. The justification can be mandatory, for example, if the non-compliance is not minor. The justification of the user can be reported to the organization for review, which can result in an improved travel policy, such as to move the bookably non-compliance reservation to the compliance area, or to move the bookably non-compliance reservation to the non-bookable area.

The compliance notices can include a recommendation notice, which indicates that the travel reservation is recommended by the travel policy. The annotation for the recommended reservation can include an explanation from the organization, explaining the reasons why the reservation is recommended by the organization, such as being supplied by a preferred supplier, or having a price that is approved by the organization. The compliance notices can include a notice of preferred suppliers based on a pre-negotiation agreement from the travel policy.

In some embodiments, for the search results complied with the travel policy, the annotation of compliance can be omitted, or can simply be annotated with an approval note, such as an approved icon.

In some embodiments, the search results are displayed based on a preference profile of the user with some search results or all search results having annotations based on the travel policy. For example, the search result can be displayed in a graphical user interface to show the annotations representing the restrictions or requirements of the travel policy.

In some embodiments, the search results can be sorted or arranged based on the travel policy, such as based on the annotations, which represent the restrictions and requirements of the travel policy. For example, the recommended search results, e.g., the reservations having a recommendation annotation, can be displayed first, followed by the compliance reservations, followed by the bookably non-compliance reservations, and followed by the non-bookable reservations.

The search results can be arranged based on a preference profile of the user. In some embodiments, the user preferences supersede the travel policy, e.g., the searched results are sorted based on the user preferences, with the top reservations most suitable to the users are displayed. In some embodiments, within the most suitable reservations, the reservations are further arranged based on the travel policy. In some embodiments, the reservations are not sorted based on the travel policy, e.g., the reservations are sorted to be displayed only according to the preferences of the user, with the inputs from the organization added as the annotations.

An innovative feature of the present travel policy is the transparency of the rational and decisions of the organization with respect to travelling. The travel policy seeks to convey the message that the organization cares and is concern about the preferences of the user. The travel policy is also hopeful that the user, when selecting travel reservations, can choose the travel reservations that are best for the organization.

The displayed search results are annotated and not hidden from the user, thus the user can know about all available candidates for the travel reservations. For example, the user can know that there is a travel reservation that satisfies the user preferences, but is not recommended or is considered non-bookable from the organization point of view. The organization can include an annotation explaining the reasons for the prevention of the user from booking the off-limit travel reservation, or why the reservation is not recommended. The annotations can further include a feedback field, for the user to provide inputs such as why the restrictions should be removed, or why the user should be allowed to choose the non-compliance or non-recommended reservation.

In some embodiments, the selections of the user with regard to the travel reservations are analyzed to assess a degree of compliance with the travel policy. The selections can include a selection for an air flight, a selection for a lodging accommodation, such as choosing a hotel, a selection for a car rental, and other selections, such as selecting food and entertainments.

The degree of compliance can be based on how the selections comply with the travel policy, e.g., how the selections comply with the restrictions and requirements of the travel policy. For example, the degree of compliance can be based on how the selections meet the expenditure limits of the travel policy, such as the user selects travel reservations that are recommended, allowed, or requiring justifications. The degree of compliance can also be based on how the selections comply with the travel policy regarding selecting preferred suppliers having a pre-negotiation agreement from the organization. The preferred suppliers typically earn a recommended annotation from the organization, so a selection of a preferred supplier can have a higher degree of compliance as compared to a selection of a non-preferred supplier.

In some embodiments, the selections and the analysis of the selections of the user are reported to the organization, such as to the department responsible to maintain and enforce the travel policy. The report to the organization can be used to tell the organization about the satisfaction of the user with regard to the travel policy, such as to assist the organization in updating the travel policy to improve satisfaction of the user. For example, if a large majority of users associated with the organization comply with the travel policy when selecting travel reservations, the travel policy can be considered to be successful, e.g., providing many happy users while exerting control over the travel expenses. The number of satisfied users can also be an indication of the regulation of the travel policy. For example, if all users are satisfied, the travel policy might be too relaxed and generous. More restrictions and tighter limitations can be applied to save money for the organization. In contrast, if more than half of the users are not satisfied, then the travel policy might be too rigid. Feedback from the users can be more carefully evaluated and applied to the travel policy, for example, to generate a happy workplace environment and to reduce travel expenses. The percentage of optimum satisfied users can be between 70 and 90%.

The report to the organization can be used to tell the organization the price or value of non-compliance with the travel policy. The report can be configured to assist the organization in regulating the travel expenditures by updating the travel policy. For example, from the analysis of the user selections, the organization can see how much the travel expenditure increases or decreases as compared to the upper or lower expense limits. Higher expenses can mean that the travel policy could be more generous to meet the demands of the user. Too high expenses can mean that the travel policy could be more rigidly enforced, to prevent budget overrun. Lower expenses can mean that the users are conscious with regarding to selecting what is best for the organization, and the travel policy could be even flexible and generous to give the users more room for innovation.

In some embodiments, the report to the organization can be used to assist the organization in setting limits of the travel expenditures to be conformed to market conditions. The report to the organization can use current market values to assist the organization in modifying the travel policy, such as to determine the limits and ranges of the travel related expenditures. Further, the report to the organization can include the feedback and the justifications of the user for selecting travel reservations having warning notices.

The travelling of the user is a necessary element of the functionality and growth of the organization, so it is important that the user can successfully make the travel reservations, in order to fulfill the organization business. If the limits of the travel expenditures are out of the normal prices of the market, the travel policy can impede the working environment of the user, since the user cannot easily make the travel reservations. In general, the limits of the travel expenditures follow the average market conditions, but not the instantaneous fluctuation of the market. Thus, the travel policy can set the limits of the travel expenditures based on the market conditions, such as having maximum limits of 20 to 40% higher than the average market prices, instead of providing fixed values.

Alternatively, the ravel policy can provide fixed values for the limits, with large ranges of the allowable expenses to allow for the widely fluctuation in market prices. The report of the user selections can assist the organization in knowing the market prices, and the behavior of the user in response to the differences in the travel policy and the market conditions.

In some embodiments, the report to the organization can be used to assist the organization in negotiating with preferred suppliers to update the travel policy. The report can provide a volume of the number of travel reservations of users of the organization, which can be used to negotiate wholesale prices. Multiple preferred suppliers can be selected, in order to satisfy the divert needs of the users.

In some embodiments, the organization can modify the travel policy based on the report of the user selections and the analysis of the user selections. Machine learning or artificial intelligence can be used to provide suggestion to the organization regarding the travel policy modification based on the user selections. For example, the travel policy can be modified to improve efficiency and cost effectiveness of the travel expenses. The travel policy can be modified to improve controls of the travel expenditures of the user. The travel policy can be modified based on the selections of the user to improve satisfaction of the user.

In some embodiments, the method for forming a travel policy for an organization can include a graphical user interface, configured to display the search results together with the annotation generated from the travel policy. The search results are displayed based on a preferential of the user, together with the annotations of the travel policy.

The graphical user interface can be configured to display explanation and reasoning from the travel policy, to give the user the feeling of concern, e.g., the goal of the travel policy is to regulate expenses while taking into consideration the comfort and preferences of the user.

The graphical user interface can be configured to accept inputs, feedback, and justifications from the users, for example, to allow the modification of the travel policy toward an optimal policy. With a two-way communication between the organization and the user with regard to the restrictions and requirements of the travel policy, the travel policy can be easily accepted by the users and the organization.

In some embodiments, the graphical user interface can be configured to display the search results based on the annotation such that search results meeting the travel policy are at the top of the search results. The search results can be sorted using a weighting mechanism based on the annotation, a preference profile of the user, and past booking made by the user.

In some embodiments, the graphical user interface can provide improvements on being user friendly with backend search capabilities. The graphical user interface can compete with available travel websites, and thus can attract users to use the organization approved travel platform in make travel reservations, instead of using other travel reservation websites.

In some embodiments, the present invention discloses a method to generate a travel policy for an organization that can provide a balance between a high controllability of users associated with the organization and a flexibility for the users. The method can include annotating the search results for a travel reservation from a user with the requirements and restrictions of the travel policy. The method can also include providing reports to the organization regarding the actions of the user in selecting the travel reservation. The method can also include updating the travel policy with inputs from the organization, which indicate feedback from the organization upon receiving the reports.

The method can provide a travel reservation booking system that can accommodate travel preferences of a user while adhering to the travel policy administered by an organization in which the user is associated with. The method can provide a travel reservation booking system in accordance with the organizational travel policy while meeting the personal requirements of the user. The method can offer the user the ability to provide inputs and feedback to the organization travel policy, in order to generate an optimal travel policy that can satisfy both the organization and the user. The optimized travel policy can eliminate the need for the user to come up with creative ways to circumvent the travel policy to be comfortable in travelling. The optimized travel policy can eliminate the need for the user to bypass the travel policy whenever possible to take advantage of travel perks offered by the organization. With the optimized travel policy, the user would be satisfied following the policy, which can prevent travel data being lost.

In some embodiments, the present invention discloses a platform, e.g., a program running on a data processing system, which can be configured to provide travel reservations to users, who are associated with an organization, looking for travel reservations, such as for air, bus, or train travel, together with lodging accommodation and car rental. The platform can communicate with the organization to obtain detail instructions regarding the travel policy for users of the platform who are associated with the organization.

In operation, the platform can receive communication from a user, such as a request for travel reservations, such as flight itineraries between cities, and/or hotel and car rental reservations in the destination city. The platform can communicate with service providers to search for candidates for the travel reservations. The search results, with each research result containing a candidate for a travel reservation, then are presented to the user together with annotations for the search results, which represent the guidelines, directions, restrictions, and requirements from the travel policy.

The annotated search results can be sorted or displayed to the user based on a preference profile of the user, e.g., the search results containing the travel reservations mostly suitable to the user, according to the preference profile, are displayed at a top portion.

The annotated search results include all search results, e.g., the search results containing the travel reservations not allowable by the organization, e.g., violating the travel policy, are also displayed. Thus, the platform can place all travel information directly in the hands of the user, e.g., the user, through the search, can know about all available travel reservations offered on the market, including the travel reservations prohibited by the organization and the travel reservations allowed by the organization.

The annotated search results are annotated with inputs from the organization, such as with notices of restriction, notices of requirements, or notices offering guidelines. Each search result can be annotated. Alternatively, some search results can have the annotation omitted, which represents a default notice. For example, search results having approval annotations can either be annotated with an approval notice or can have the approval annotation omitted. The search results without the annotations can be the travel reservations having met all the requirements and restrictions of the travel policy.

The user can select one or more travel reservations from the search results. The actions of the user can be reported to the organization. The travel policy can be updated to reflect an improvement of the travel policy, e.g., to provide a balance between the need to control the travelling of the users by the organization and the desire to be comfortable and cost saving by the users.

In some embodiments, the travel policy can assist in generating a summary of the corporate travel expenses by category. By providing a travel policy that is observed by all users in the organization, all users can use the travel platform to make reservations when travelling on organization business. As such, the travel platform can provide the organization with estimations of travel expenses and category breakdowns based on actions of the users. These estimates can be accurate and up to date, including the changes made to early reservations by the users.

In some embodiments, the travel policy can assist in maintaining consistency in travel and to keep costs at a reasonable level. By providing a travel policy that is observed by all users in the organization, there can be no travel booking outside of the travel policy. For example, new travel suppliers (e.g., airlines, hotels, and car rental agencies) with new pricing rates can be included in the updated travel policy to ensure satisfaction of the users in compliance with the travel policy.

The travel policy can provide an overall cost saving, instead of individual low prices. For example, even though an out-of-policy hotel rate is the same or less than the in-policy rate, the selection of the in-policy hotel can provide hotel-night volume or qualify for other incentives with the preferred hotel supplier. The reason can be communicated to the user, for example, through the annotation having an explanation field, so that the user can be aware of the hidden benefits of the recommending higher-rate travel reservations.

In some embodiments, the travel platform can offer bonus point to the users, for example, to prevent the users from booking with out-of-policy suppliers or reservations to gain personal rewards.

In some embodiments, the travel platform can collect user actions in selecting travel reservations from travel search results annotated with data from a travel policy, and analyzing the user actions to modify the travel policy. The travel platform can employ artificial intelligent algorithms linking the user behavior and the travel policy to generate a travel policy suitable for both organization and users.

In the present specification, the reference is made to flight reservations. It is readily understood that the travel reservation described herein are applicable to other types of travel services, such as bus transportation, rail transportation, lodging accommodation such as hotel reservations, car rentals, tours, food and entertainment reservations.

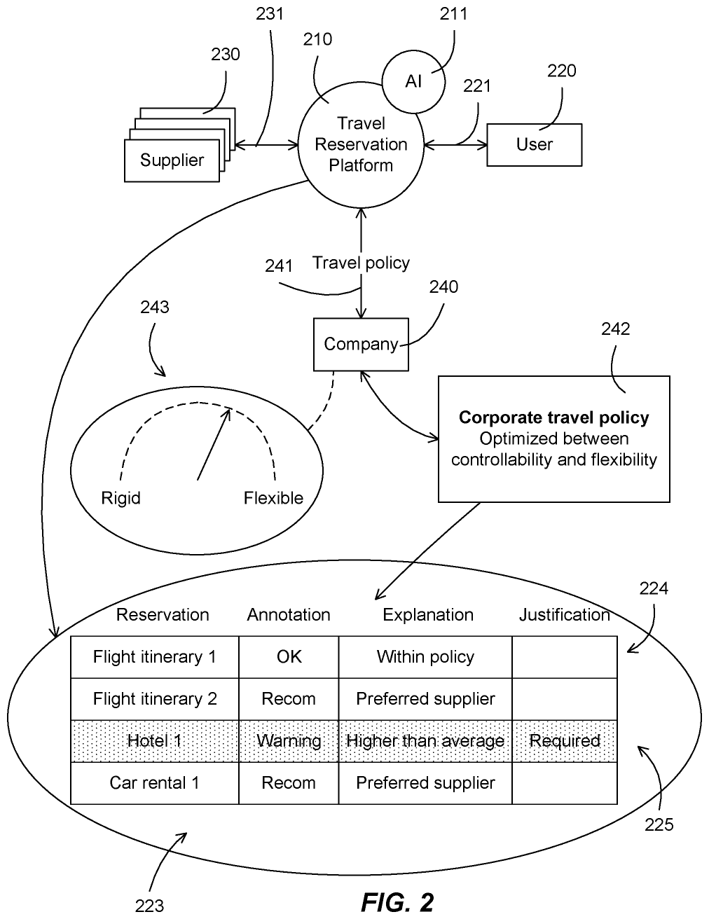

FIG. 2 illustrates a schematic for a travel platform for generating a travel policy for an organization according to some embodiments. A user 220 can contact 221 a travel platform 210 to obtain candidates for travel reservations. The platform can be contacted by the user using a mobile phone, a desktop computer or some other type of computing device. The contact 221 can include a request for searching available travel reservations meeting a user requirement, including airline, car rental, and hotel reservations. For example, the request can be for a flight itinerary, with departure and destination locations, and time and date of the travel. Alternatively, the request can also for a lodging accommodation and car rental. The request can be sequential, e.g., a flight reservation is provided first, followed by a hotel and car reservation.

The user can provide search criteria and initiate searches for available travel services. The platform 210 can interface 231 with one or more suppliers or data depositories 230. For example, for airlines reservations, the travel platform can contact with the reservation systems of the airlines or the data depository Global Distribution System (GDS) which contains reservations for multiple airlines.

Search results 223 meeting the user search criteria can be displayed to the user, including the candidates for reservation, and the annotations based on a travel policy 242 of a company 240. The company can provide 241 the platform with the travel policy, such as providing the platform with restrictions and requirements on travel reservations that meet the travel policy guidelines. The information from the travel policy supplied by the company to the platform can be used to annotate the search results 223, such as to provide inputs to the individual travel reservations. For example, the travel reservation can be annotated with an approval note, a recommendation note, a warning note, or a forbidden note. The annotations can include explanations for the restrictions on the travel reservations. For example, a recommendation note can be accompanied by an explanation stating that the recommended reservation is from a preferred supplier. A warning note can be accompanied by an explanation stating that the fare is higher than average. The annotations can include fields for feedback or for justification from the user. For example, if the user wants to book a reservation with a warning notice, a justification for the booking action is required. Alternatively, even though the user is not allowed to book a non-bookable reservation, the user can provide a feedback to the company through the feedback field.

The user can select a travel reservation 225, among the display travel reservations 224. The selection can be processed by the platform. The selections can be automatically approved and the selected travel reservation booked for the user if the selection is within the approval area of the travel policy. The selections can be forwarded to the company for approval, if the selection requires additional approval from the company. For example, a minor warning reservation can carry an automatic approval if the user provides the required justification. A major warning reservation can require that the travel reservation is forwarded to the company for processing before deciding whether or not the reservation is approved.

In some embodiments, the present method can provide multiple classes of policy violations, such as forbidden violations, high-level warning violations, or low-level warning violations. In forbidden violations, the user is not allowed to select the forbidden reservations. However, the method does not hide the reservations, but instead, allow the organization to explain the forbidden reason, together with an opportunity for the user to provide feedback to the organization, such as to state why the forbidden reservations indeed should be allowed.

In high-level violations, the user is allowed to select the high-level violation reservations. However, the method requires the user to submit justification, and also requires the user to wait for a review on whether or not the justification is accepted. In low-level violations, the user is also allowed to select the low-level violation reservations. The method also requires the user to submit justification but does not require the user to wait for a review. The low-level violation reservations can be automatically approved with the submission of a justification.

Data from the users, such as the user selections, the user inputs on the search results, and an analysis of the user actions, can be provided to the company at a certain interval. The reporting data can include individual actions and behavior, trend analysis, year-to-date totals, and chronic policy violations. The company can use the data to modify the travel policy, such as to be more user friendly or user satisfactory, while maintaining the core principle of the travel policy according to the organization. The modified travel policy can be communicated with the platform for updating the travel policy on the platform.

With the continuous feedback, the travel policy can provide a balance 243 between being rigid and flexible, to make the user happy by providing comfort to the user, and to make the company happy by provide early data on the travel plans and expenses from the user.

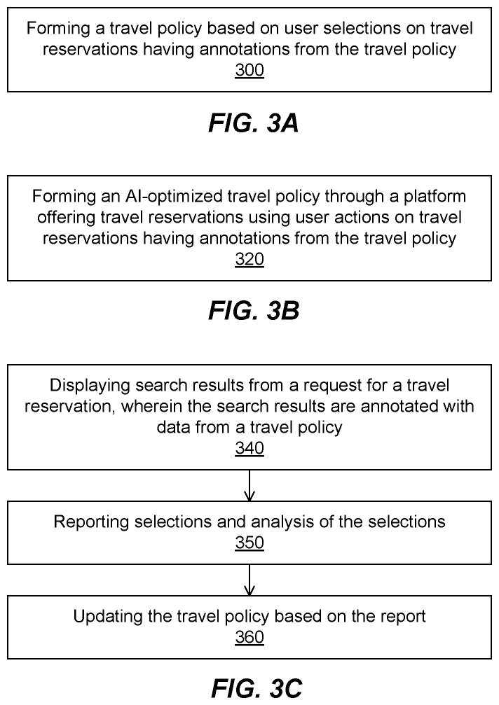

FIGS. 3A-through 3C illustrate flow charts for a process to form a travel policy according to some embodiments. In FIG. 3A, operation 300 forms a travel policy based on user selections on travel reservations having annotations from the travel policy.

In FIG. 3B, operation 300 forms an AI-optimized travel policy through a platform offering travel reservations using user actions on travel reservations having annotations from the travel policy.

In FIG. 3C, the method can include generating a graphical user interface for a listing of the search results, with the search results rendered for display in an order based on at least one annotation.

Operation 300 displays search results from a request for a travel reservation, with the search results annotated with data from a travel policy. A user can enter basic trip parameters and then request a search for the available reservations.

For example, a user can send a travel request to a platform. The travel request can include a departure location, an arrival location, and a date of travel. The platform can search for available flights meeting the user specifications. The platform then can show the searched flights, which can be sorted based on a user preference, such as ordered by price. Information about the flights can be shown, such as the airline name, the departure time, the arrival time, and the airfare. Other information can be included, such as the name of the departure and arrival airports. Other details of the flights can be shown, such as details of the flight characteristics, including the physical specifications of the airplane and the services of the flight crew.

In addition, there can be annotations for the search results. The search results can include a list of available hotels in the destination city. The user can also request availability at certain preferred hotels. The search results can include a list of preferred rental car vendors, with special negotiated rates.

Operation 350 reports selections and analysis of the selections. The user actions and the analysis of the user actions can be reported to the company, such as to the corporate travel manager.

Operation 360 updates the travel policy based on the report. The organization can use the user selections for bargaining with preferred suppliers, such as to show the number of bookings from users of the organization. The report can allow the organization to change the travel policy to reflect saving from the user selections, to restrict wastes, or to allow for expense adjustments during special times.

In some embodiments, the travel policy can be updated based on the actions of the user. For example, the platform can display multiple reservations with annotations from existing travel policy. Based on the selections of the user, the travel policy can be updated to reflect the selections, e.g., to improve the satisfaction of the user without compromising the organization requirement and restrictions.

The analysis of the user actions can include a trend analysis for forecasting. For example, the analyzed air travel reservations, the analyzed car rental reservations, and the analyzed hotel reservations can report the percentage of policy compliance and the policy warning for individual users, together with selected air carriers, with air travel for a given city pair, overall air cost for a given city pair, and average leg fare cost for a given city pair, and with car rental companies and hotel companies,

In some embodiments, the platform can apply machine learning to optimize the travel policy, such as assigning weights to each selection and action of the users.

In some embodiments, the method can include a travel reservation platform, which is configured to contact suppliers for searching for available travel reservations, such as contacting airlines for air reservations, contacting car rental agencies for car rental reservations, and contacting hotel managements for hotel reservations. The travel platform can be configured to communicate with users of an organization, for example, to provide search results for travel reservations. The travel platform can be configured to communicate with the organization, for example, to obtain a travel policy of the organization, including restrictions and requirements of the travel policy, and to provide reports about the user actions.

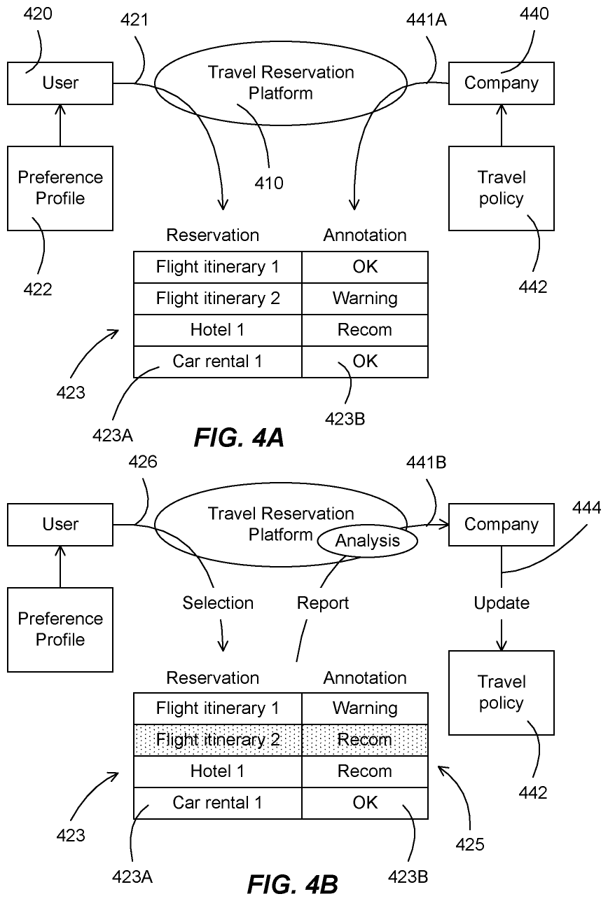

FIGS. 4A and 4B illustrate configurations for communication with the travel platform according to some embodiments. In FIG. 4A, a travel reservation platform 410 can have access to multiple suppliers for searching and making reservations for travel related services. The platform 410 can also communicate with a company 440, such as an organization or a business entity, for supplying travel reservation services to the company. The company can have a travel policy 442, which can govern all aspects of business travel for users associated with the company, such as for employees or contractors of the company. The company can communicate 441A with the platform, to supply to the platform the travel policy, such as the rules and regulations, including restrictions and requirements for business travel of the users associated with the company.

The travel platform 410 can be configured to provide travel reservation services to users, including a user 420 who is associated with the company 440, e.g., an employee or a contractor who can employ the services of the platform for making travel reservations for business purpose. The user can have a preference profile 422, which can be provided to the platform, so that the platform can process the available travel reservations, such as to sort the reservations, to present to the user the reservations mostly suitable to the user. In some embodiments, the user does not have a preference profile, and the platform can use a default profile, such as low fares and high comfort.

In operation, the user 420 can communicate with the platform 410, for example, to request 421 for a travel reservation service. The travel service can include a travel reservation for a flight itinerary, a travel reservation for a car rental, or a travel reservation for a hotel. The request can include a departure location, a destination location, and a date of travel. For a flight reservation, the platform can search for flight itineraries meeting the departure and destination locations, such as the departure and destination airports at the location cities, and the date of travel. For a car rental reservation, the platform can search for car rental availability at the destination location, such as at the airport of the destination city. For a hotel reservation, the platform can search for hotel availability at the destination location, such as within 10 to 30 mile radius at the destination city.

Upon receiving the request 421 for a travel reservation, the platform can perform a search on the supplier websites or on the supplier databases, using data from the travel request. For example, the platform can contact airline websites, or repositories of multiple airlines such as GDS, with departure location, destination location, and date of travel, to obtain available flight itineraries meeting the user requirements. The platform can contact car rental agencies and hotel management services to obtain available car rentals and hotels meeting the user requirements. The searches for air travel, car rental, and hotel accommodation can be performed at a same time to be presented to the user, or can be performed one at a time, e.g., after the user finishes selecting a flight itinerary, the platform can search and present car rental availability, followed by hotel availability.

After finishing the search, the search results can be annotated with the rules and regulations from the travel policy of the company that the user is associated, if the user is traveled for the business of the company. For example, the platform can provide an annotation on each search result, and the reservation and the annotation then can be displayed and presented to the user.

In some embodiments, the search results are arranged or sorted according to a preference profile of the user. If the user has no preference profile, a default preference profile can be used, which can be a generic profile, such as low fare, high comfort, and high convenience.

In some embodiments, the method can include a graphical user interface, rendered to display the search results of a request for a travel reservation. The graphical user interface is also rendered to display annotations for the search results, such as for each search result. The graphical user interface can be configured to display the search results based on the preference profile, e.g., either the user preference profile or the default preference profile. In addition, only the search results to be displayed in the graphical user interface are processed to add the annotations, e.g., the search results not displayed to the user are not processed to be annotated. Thus, in some embodiments, only the search results to be displayed to the user are processed to be annotated. The graphical user interface can be configured so that a search result considered to be displayed in the graphical user interface can pass through a processing module to acquire an annotation which represents the rules and regulations of the travel policy, e.g., the annotation indicates whether the search results meets or exceeds the travel policy restrictions and requirements.

As shown, the graphical user interface can show a displayed search results 423, in which each search result 423A, representing a candidate for a travel reservation, is annotated with an annotation 423B. Further, the displayed search results 423 are shown with a mixture of different reservations, such as flight reservation, car rental reservation, and hotel reservation. In some embodiments, the different types of reservations are displayed separately. For example, only the flight reservations are shown in the graphical user interface. After the user selects a flight reservation, the graphical user interface can be processed to continue with car rental reservations, followed by hotel reservations.

In FIG. 4B, the user can select 426 travel reservations, together with performing other actions to complete the booking process, such as satisfying any requirements imposed by the annotations. For example, the user can select a flight reservation 425. Since the flight reservation 425 is annotated with a recommendation notice, there can be no additional action from the user, e.g., the selection of the user meets the travel policy requirements and restrictions of the company. The platform then can process the selected reservation, such as booking the flight reservation and sending a confirmation to the user. The process can continue for other reservations, such as for a car rental reservation, for a hotel reservation, and for other reservations such as food and entertainments.

In some embodiments, if the user selects a travel reservation that requires an approval from the company, the platform can send an inquiry to the company, and then waiting for an answer from the company before proceeding.

After an interval period, the actions of the user can be correlated and processed, such as performing an analysis on the user actions, including a summary of the user selections, a history and trend of the user selections, and the levels of compliance to the company travel policy. The platform then can communicate 441B with the company, such as to send a report to the company. The company can use the report to update 444 the travel policy, in order to improve satisfaction of the user while still maintaining the company control over the travel aspects, such as to control the travel expenses to provide a cost effective travel expenditure, e.g., a travel expenditure scheme that is generous to the user but not wasteful at a same time.

The company can communicate with the platform to provide the updated travel policy to the platform. The platform then can update the existing travel policy with the updated travel policy. The feedback process can continue, with the company continuously updating the travel policy in response to the user actions in selecting travel reservations having annotations from the travel policy.

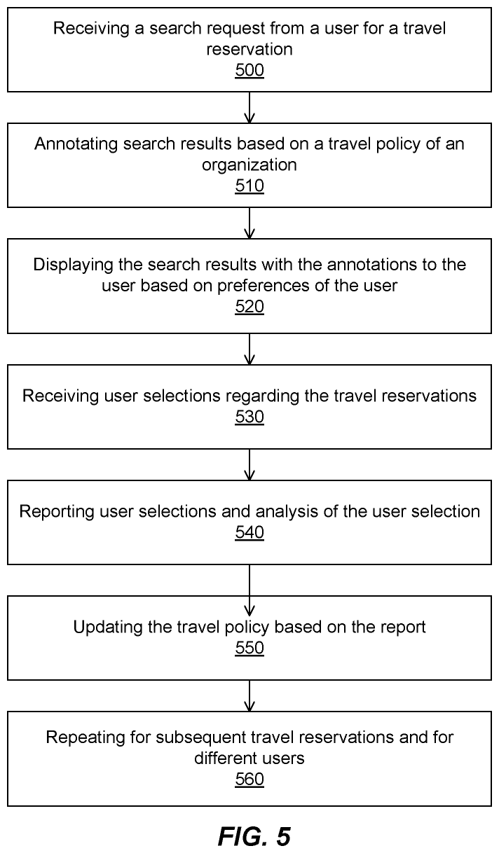

FIG. 5 illustrates a flow chart for a travel policy formation according to some embodiments. Operation 500 receives a search request from a user for a travel reservation, such as a flight reservation, a car rental reservation, or a hotel reservation. The reservation request can include information to allow for a search of matching candidates.

Operation 510 annotates search results based on a travel policy of an organization. The annotations can be provided on each search result. The annotations can be provided only on search results that are to be displayed to the user, thus can reduce the processing time. For example, the search results can be arranged and sorted based on a preference profile, such as a preference profile of the user or a default preference profile, if the user does not have a preference profile. The top arranged search results can be displayed. Further, the search results can be re-arranged and re-sorted based on inputs of the user. The search results to be displayed can be processed so that each search result can have an annotation. For example, the platform can include an annotation module, which can receive a search result and, after processing, generating an annotation for the search result based on the rules and regulations of the travel policy.

Operation 520 displays the search results with the annotations to the user based on preferences of the user. The displayed search results can be arranged based on the annotations, after being arranged by the preference of the user.

Operation 530 receives user selections regarding the travel reservations. The user selections can include a justification or a feedback, which can be required or optional, determined by the annotations for the selected search results that are selected by the user.

Operation 540 reports user selections and an analysis of the user selections. The actions of the user, including the selections, justification, feedback, and other actions, can be reported to the company. Further, an analysis of the user actions, including past user actions, e.g., user actions on reservation selections in the past, can also be reported.

Operation 550 updates the travel policy based on the report. The company can update the travel policy. The company can communicate with the platform regarding the updated travel policy, so that the platform can update the existing travel policy with the updated travel policy.

Operation 560 repeats for subsequent travel reservations and for different users. With the constant feedback of the user actions and travel policy updating, an improved or optimized travel policy can be formed, with a balance between maximum user satisfaction and company control and performance. For example, a goal of the travel policy is to maximize the employee performance, e.g., to achieve the best work from the employee. To accomplish the task, high employee satisfaction, such as on travel reservations, is necessary. Thus, the travel policy is optimized to obtain the best performance of the employee, such as to maximizing the employee satisfaction while not damaging the company operations.

In some embodiments, the travel policy can be improved or optimized based on feedback from the users. For example, each travel reservation to be shown to the user can be annotated with the rules and regulations of the current travel policy. After the selections and feedback from the user with regard to the current travel policy, the current travel policy can be updated to improve the user satisfaction, as long as the improvements do not damage the company operations. For example, a goal of the travel policy is to minimize the travel expenses while not affecting the employee performance. Thus, an optimized travel policy can be a travel policy that provides a balance between travel cost and employee satisfaction.

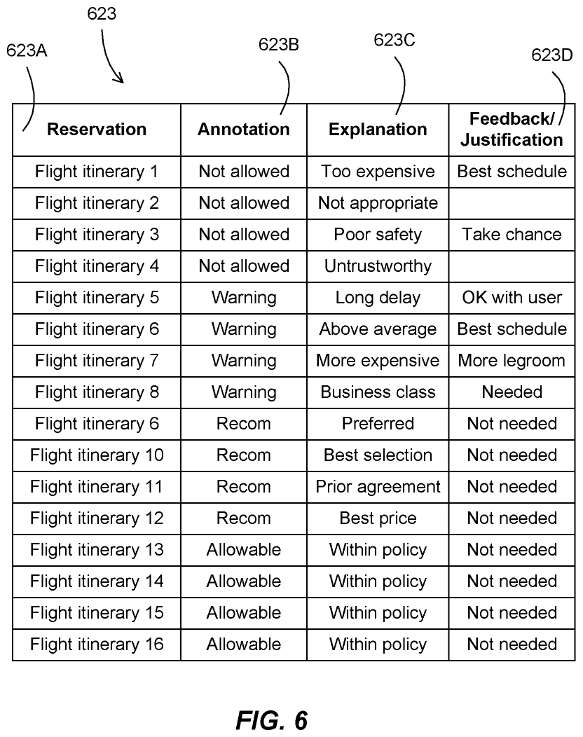

FIG. 6 illustrates a display of a graphical user interface according to some embodiments. The graphical user interface can include a display 623 for the search results. The displayed search results can include reservations 623A, e.g., the candidates for the travel reservations matching the requirements of the user. The displayed search results can include annotations 623B, which can be a summary of the assessment of the travel policy regarding the reservations 623A.

The displayed search results can include explanations 623C, which can be a communication from the company to the user, for example, to explain the reasons for the classification of the reservations 623A. The communication between the company and the user is important, since it can let the user know that the company classifies the reservations for a reason. The explanation can be important because sometimes the reason can be not obvious from the present facts. For example, a low fare reservation might not obtain a recommendation classification as compared to a higher fare reservation, since the company can obtain additional benefits from the suppliers providing the higher fare reservation.

The displayed search results can include feedback or justifications 623D, which can be a communication from the user to the company, for example, to justify the reasons for the user selecting the reservations 623A or to provide feedback to the company regarding non allowed reservations. The justification can be informal, e.g., the company simply requires that the user thinks before booking the reservation. Thus, the user can book the reservation after providing the justification. The justification can be formal, e.g., the company would have to consider the user justification before approving the reservation.

In some embodiments, the annotations in the displayed search results 623 can include a summary 623B, such as a category of the search results. For example, a search result can be categorized as being forbidden, or unbookable or not allowed. The user can view, e.g., knowing that there is a search result, the search result, but cannot book or select the not-allowed search result. The not-allowed summary can be followed by an explanation, such as the reservation is too expensive, the reservation is not appropriate, e.g., a first class flight reservation for a regular employee, the reservation is supplied by an airline having poor safety record, or by a supplier having untrustworthy reputation. The not-allowed summary can be followed by a feedback and justification from the user, such as the reservation, though expensive, can provide the best flight schedule, or that the reservation, though through a poor safety airline, can be best suited to the user and the user is willing to take the chance. The not-allowed category can have sub-classes.

A search result can be categorized as being warned by the company. The user can select the warned search results but is required to supply a justification to the company. The warned summary can be followed by an explanation, such as the reservation is having a long delay, the price of the reservation is above average, the reservation is more expensive than average flights, or the reservation is not appropriate, e.g., a business class flight reservation for a regular employee.

The warning can have multiple sub-classes, such as a high warning level and a low warning level. In the high warning level, the user would need to wait for explicit approval from the company after the justification received and reviewed. In the low warning level, the user can be automatically approved after sending the justification. The warned summary can be followed by a feedback and justification from the user, such as the reservation, though having long delay, is acceptable by the user, or that the reservation, though having higher cost than average, can provide long legroom for the user who is also taller than average, or that the reservation, though being a business class and generally not allowable for a regular employee, can be particular suited for the current situation in which this is a red-eye flight and the user needs the extra comfort to be ready in the morning.

A search result can be categorized as being approved by the company. The user can select the approved search results and can be automatically approved. The approved summary can be followed by an explanation, such as the reservation is from a preferred supplier, the reservation is the best selection from the company point of view, the reservation is from a supplier having a prior agreement with the company, the reservation is having a best price from the company point of view, or the reservation is within the policy.

The approval can have multiple sub-classes, such as a recommending level and an allowable level. The recommending level is more preferred by the company, as compared to the allowable level, but there can be no difference in the booking process from the user point of view.

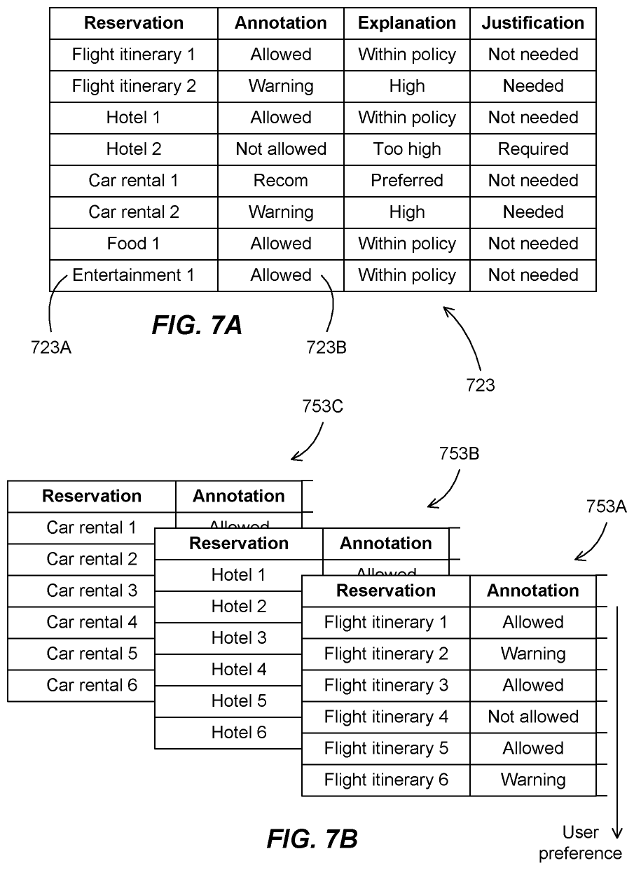

FIGS. 7A and 7B illustrate configurations of displayed search results according to some embodiments. In FIG. 7A, a display 723 can include reservations for flight reservations 723A, car rental reservations, and hotel reservations. The display can include annotation 723B for the reservations 723A. Thus, a user can select a flight reservation, a car rental reservation, and a hotel reservation from the display of annotated search results.

In FIG. 7B, there can be multiple displays, such as a display 753A for flight reservations, a display 753B for car rental reservations, and a display 753C for hotel reservations. The user can select a flight reservation. After completing the flight reservation, the user can then select a car rental reservation and a hotel reservation. The display can be arranged in order of the user preferences.

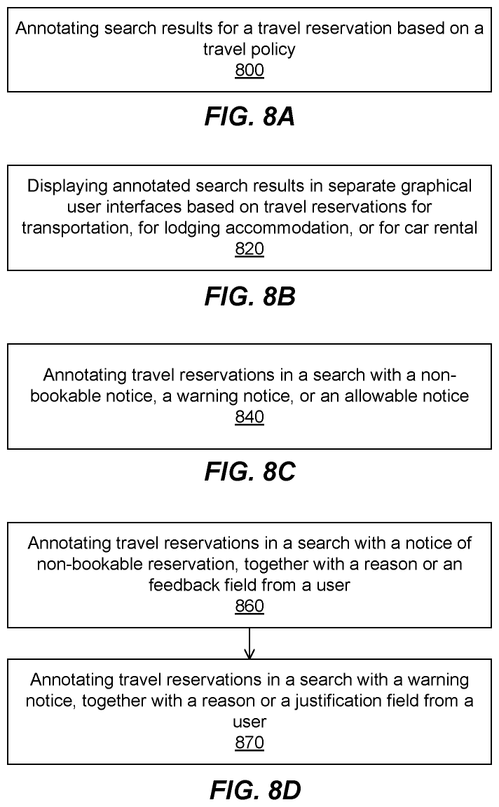

FIGS. 8A through 8D illustrate flow charts for search result displays according to some embodiments. In FIG. 8A, operation 800 annotates search results for a travel reservation based on a travel policy. The annotations can include a classification of the search results, such as not allowable, warned, or approved. The annotations can include a communication from the company or a communication from the user.

In FIG. 8B, operation 820 displays annotated search results in separate graphical user interfaces based on travel reservations for transportation, for lodging accommodation, or for car rental. The user can select a flight reservation and perform the booking of the selected flight reservation. Afterward, the user can select a car rental reservation, followed by a selection of a hotel reservation. Other reservations can be selected, such as food reservation and entertainment reservation.

In FIG. 8C, operation 840 annotates travel reservations in a search with a non-bookable notice, a warning notice, or an allowable notice. The annotation can be derived from the travel policy, e.g., interpreting the travel policy with regard to the individual search results.

In FIG. 8D, operation 860 annotates travel reservations in a search with a notice of non-bookable reservation, together with a reason or a feedback field from a user. Operation 870 annotates travel reservations in a search with a warning notice, together with a reason or a justification field from a user.

In some embodiments, the travel policy can be configured to observe market conditions, instead or in addition to provide fixed values for the travel expenses. For example, an air fare can be considered as too high as compared to an average value offered by the market, and not as compared to a fixed value. The determination of travel expenses based on market conditions can allow the user to book comfortable flights under various scenarios, such as a low fare flight in discounted market, an average fare flight in normal market, and a high fare flight in an emergency or high demand market.

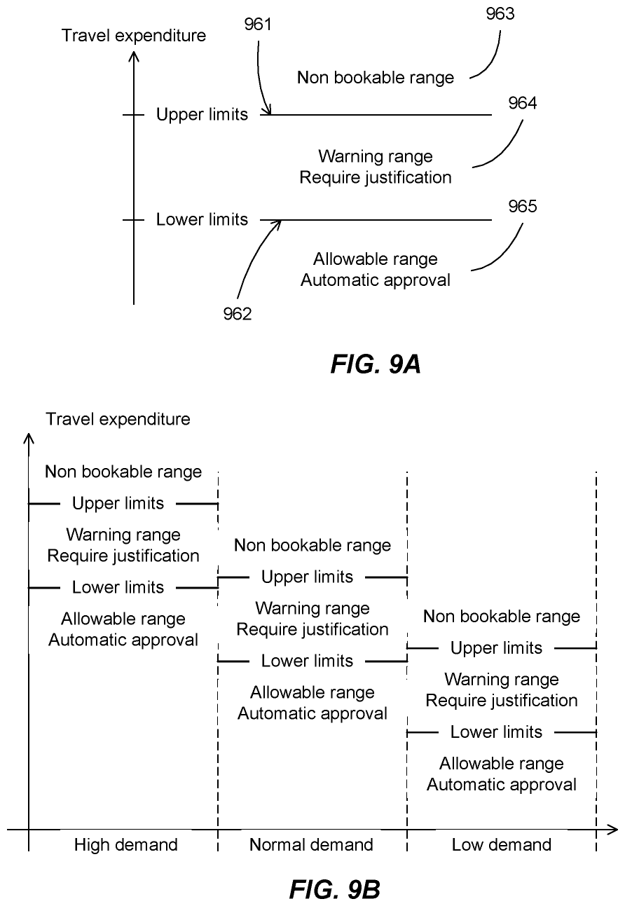

FIGS. 9A and 9B illustrate configurations of travel expenditures based on market conditions according to some embodiments. In FIG. 9A, the travel expenditure can be based on a fixed scale. The travel expenses can be divided into multiple ranges, such as an upper range 963, a middle range 964 and a lower range 965 of expenses. An upper limit value 961 is used to separate the upper range and the middle range. A lower limit value 962 is used to separate the upper range and the middle range.

In the lower range of expenses, the reservations are automatically approved, since the expenses are within an average range of expenses. The lower range can be considered as the allowable range. In the middle range of expenses, the reservations are approvable, but requiring justification, since the expenses are above the average range. The middle range can be considered as the warning range. In the upper range of expenses, the reservations are not allowed, since the expenses are way above the average range. The upper range can be considered as the non-allowable range or the non-bookable range.

The ranges can be further divided into sub ranges. For example, the middle range or the warning can be divided into upper middle range, e.g., high warning range, and lower middle range, e.g., low warning range. In the high warning range, explicit approval from the company is required. The user first needs to submit a justification to justify the selection of a travel reservation having expenses in the high warning range. The justification is received and reviewed by the company. If the justification is accepted, the reservation is approved, and the user can book the reservation. Otherwise, the reservation is rejected.

In the low warning range, automatic approval from the company is provided. The user first still needs to submit a justification but can book the reservation after submitting the justification.

In FIG. 9B, the travel expenditure can be based on a market condition scale. For example, in normal market condition, the upper and lower limits can be averaged from the market data. In high demand market, the upper and lower limits can be higher than normal, e.g., can be determined from the market condition. In low demand market, the upper and lower limits can be lower than normal, e.g., can be determined from the market condition.

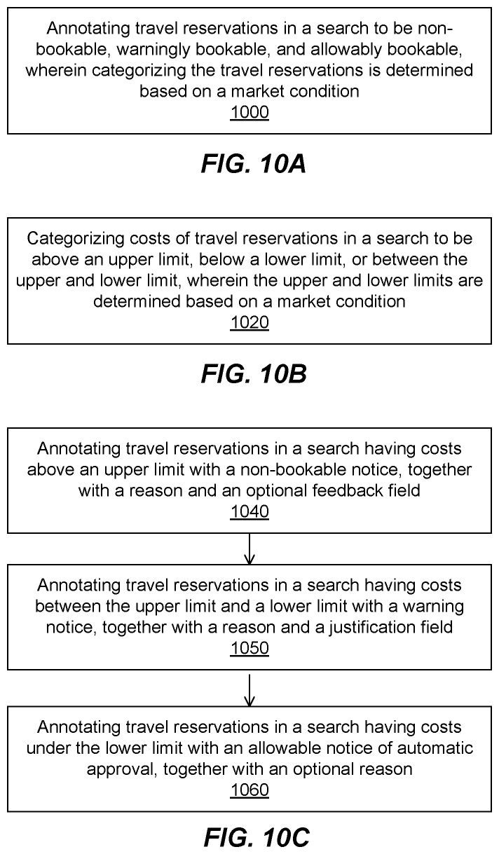

FIGS. 10A through 10C illustrate flow charts for search result displays according to some embodiments. In FIG. 10A, operation 1000 annotates travel reservations in a search to be non-bookable, warningly bookable, and allowably bookable, wherein categorizing the travel reservations is determined based on a market condition.

In FIG. 10B, operation 1020 categorizes costs of travel reservations in a search to be above an upper limit, below a lower limit, or between the upper and lower limit, with the upper and lower limits determined based on a market condition.

In FIG. 10C, operation 1040 annotates travel reservations in a search having costs above an upper limit with a non-bookable notice, together with a reason and an optional feedback field. Operation 1050 annotates travel reservations in a search having costs between the upper limit and a lower limit with a warning notice, together with a reason and a justification field. Operation 1060 annotates travel reservations in a search having costs under the lower limit with an allowable notice of automatic approval, together with an optional reason.

In some embodiments, the selections of the user, together with an analysis of the user actions, including past history and data trend, can be reported to the company, for example, to provide the company with the compliance of the users with the travel policy. The report can allow the company to modify the travel policy to improve the user satisfaction and also to improve a cost effectiveness of the travel policy.

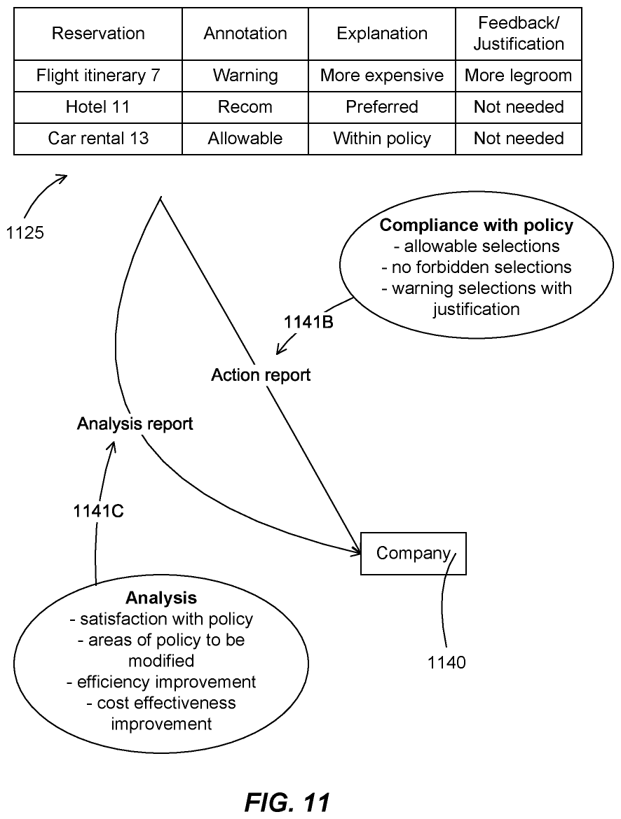

FIG. 11 illustrates a process for reporting user actions according to some embodiments. From selections 1125 of the user on the search results for the travel reservations, the platform can provide an action report 1141B to the company 1140. The action report can include the compliance of the user with the travel policy, including the allowable selections and the warning selections with justification. The platform can process and provide an analysis report 1141C to the company. The analysis report can include the satisfaction of the user with policy, the areas of policy to be modified, the efficiency improvement, and the cost effectiveness improvement.

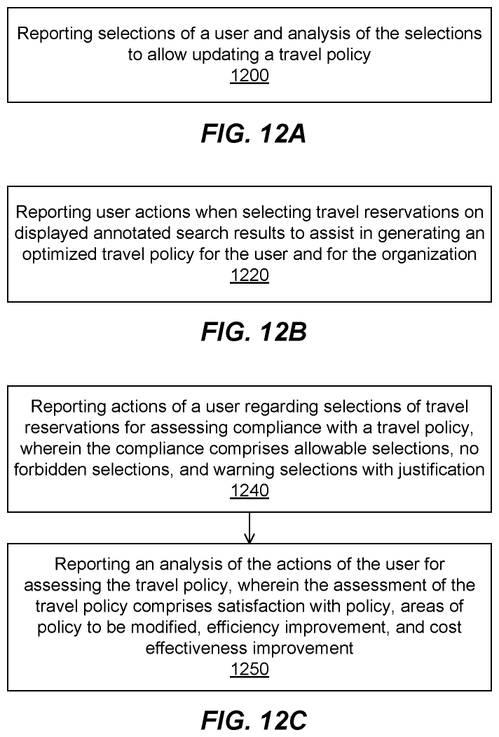

FIGS. 12A through 12C illustrate flow charts for reporting user actions according to some embodiments. In FIG. 12A, operation 1200 reports selections of a user and analysis of the selections to allow updating a travel policy. In FIG. 12B, operation 1220 reports user actions when selecting travel reservations on displayed annotated search results to assist in generating an optimized travel policy for the user and for the organization.

In FIG. 12C, operation 1240 reports actions of a user regarding selections of travel reservations for assessing compliance with a travel policy. The compliance can include allowable selections, no forbidden selections, and warning selections with justification. Operation 1250 reports an analysis of the actions of the user for assessing the travel policy. The assessment of the travel policy can include satisfaction with policy, areas of policy to be modified, efficiency improvement, and cost effectiveness improvement

In some embodiments, the company can modify the travel policy based on the reports of user actions and the reports on the analysis of the user actions. The modification can be designed to improve the satisfaction of the user, together with lowering travel expenses and higher control on the user travel.

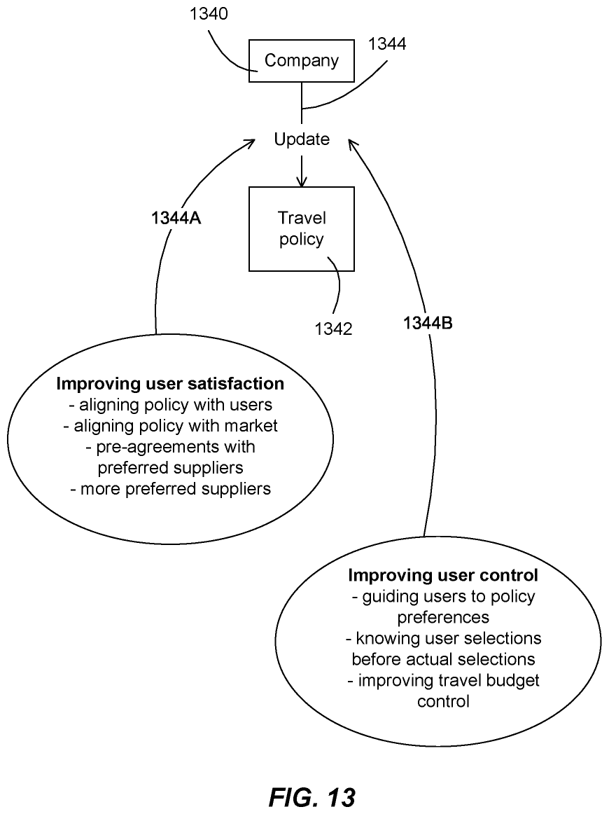

FIG. 13 illustrates a process for updating a travel policy according to some embodiments. A company 1340 can updates 1344 the travel policy 1342, for example, based on the reports from the platform. The travel policy update 1344A can include modifications to improve user satisfaction, such as to align the travel policy with the users, to align the travel policy with the market, to make pre-agreements with preferred suppliers, and to have more preferred suppliers. The travel policy update 1344B can include modifications to improve user control and lower travel cost, such as to guide users to the preferences of the travel policy, to know the user selections before the actual selections, and to improve the travel budget control.

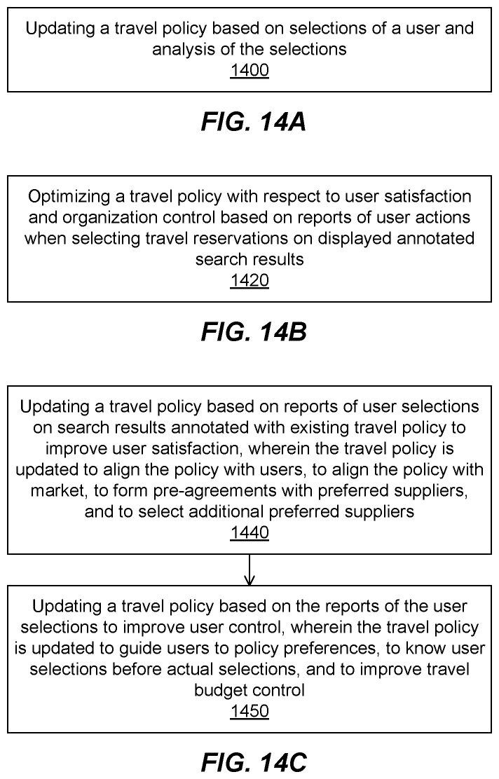

FIGS. 14A through 14C illustrate flow charts for updating a travel policy according to some embodiments. In FIG. 14A, operation 1400 updates a travel policy based on selections of a user and analysis of the selections. In FIG. 14B, operation 1420 optimizes a travel policy with respect to user satisfaction and organization control based on reports of user actions when selecting travel reservations on displayed annotated search results.

In FIG. 14C, operation 1440 updates a travel policy based on reports of user selections on search results annotated with existing travel policy to improve user satisfaction, with the travel policy updated to align the policy with users, to align the policy with market, to form pre-agreements with preferred suppliers, and to select additional preferred suppliers. Operation 1450 updates a travel policy based on the reports of the user selections to improve user control, with the travel policy updated to guide users to policy preferences, to know user selections before actual selections, and to improve travel budget control.

In some embodiments, the present invention discloses a computer program having machine-readable instructions to cause a processing device to implement any one of the methods described above. The present invention also discloses a machine-readable storage, having stored there on a computer program having a plurality of code sections for causing a machine to perform the various steps and/or implement the components and/or structures disclosed herein. In some embodiments, the present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied in a variety of program storage devices, such as a diskette, a hard disk, a CD, a DVD, or a nonvolatile electronic memory. The software program may be run on a variety of devices, including a processor or a processing device to perform any one of the methods described above.

In some embodiments, the methods can be realized in hardware, software, or a combination of hardware and software. The methods can include computer-implemented methods, using a computer or a data processing system to execute the methods, including executing operations by a hardware processor. The methods can be realized in a centralized fashion in a data processing system, such as a computer system or in a distributed fashion where different elements are spread across several interconnected computer systems. Any kind of computer system or other apparatus adapted for carrying out the methods described herein can be used. A typical combination of hardware and software can be a general-purpose computer system with a computer program that can control the computer system so that the computer system can perform the methods. The methods also can be embedded in a computer program product, which includes the features allowing the implementation of the methods, and which when loaded in a computer system, can perform the methods.

In some embodiments, the present invention discloses a system having a non-transitory memory and one or more hardware processors coupled to the non-transitory memory and configured to read instructions from the non-transitory memory to cause the system to perform operations necessary to perform the methods described above.

The terms “computer program,” “software,” “application,” variants and/or combinations thereof, in the context of the present specification, mean any expression, in any language, code or notation, of a set of instructions intended to cause a system having an information processing capability to perform a particular function either directly. The functions can include a conversion to another language, code or notation, or a reproduction in a different material form. For example, a computer program can include a subroutine, a function, a procedure, an object method, an object implementation, an executable application, an applet, a servlet, a source code, an object code, a shared library/dynamic load library and/or other sequence of instructions designed for execution on a data processing system, such as a computer.

In some embodiments, the methods can be implemented using a data processing system. A data processing system can include a graphical display monitor with a graphics screen for the display of graphical and textual information, a keyboard for textual entry of information, a mouse for the entry of graphical data, and a computer processor. In some embodiments, the computer processor can contain program code to implement the methods. Other devices, such as a light pen (not shown), can be substituted for the mouse. This system may be one of the many types well known in the art, such as a mainframe computer, a minicomputer, a workstation, or a personal computer.

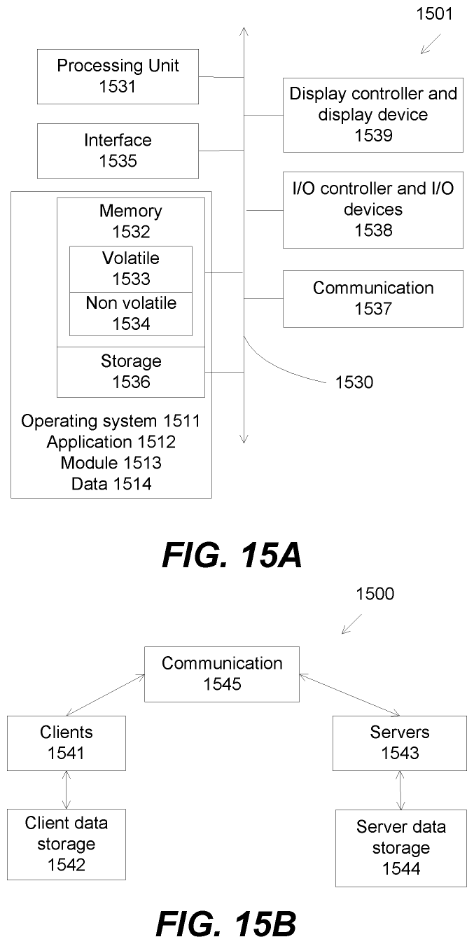

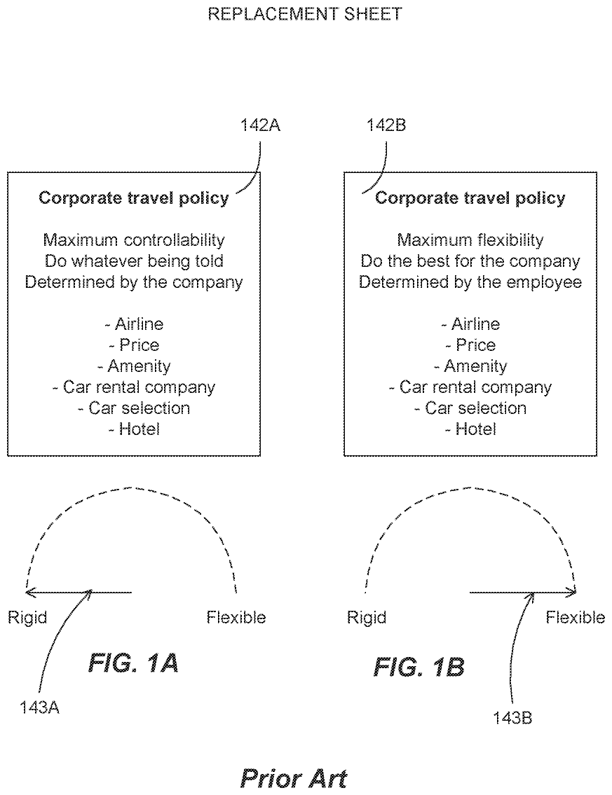

FIGS. 15A and 15B illustrate computing environments according to some embodiments. FIG. 15A shows a computing environment. An exemplary environment for implementing various aspects of the invention includes a computer 1501, comprising a processing unit 1531, a system memory 1532, and a system bus 1530. The processing unit 1531 can be any of various available processors, such as single microprocessor, dual microprocessors or other multiprocessor architectures. The system bus 1530 can be any type of bus structures or architectures. The system memory 1532 can include volatile memory 1533 and nonvolatile memory 1534.

Computer 1501 also includes storage media 1536, including removable storage media or nonremovable storage media, and volatile or nonvolatile disk storage. A removable or non-removable interface 1535 can be used to facilitate connection. These storage devices can be considered as part of the I/O device 1538 or at least they can be connected via the bus 1530. Storage devices that are “on board” generally include EEPROM used to store the BIOS.

The computer system 1501 further can include software to operate in the environment, such as an operating system 1511, system applications 1512, program modules 1513 and program data 1514, which are stored either in system memory 1532 or on disk storage 1536. Various operating systems or combinations of operating systems can be used.

Input devices can be used to enter commands or data, and can include a pointing device such as a mouse, stylus, touch pad, and other devices such as keyboard, microphone, connected through interface ports 1538. Interface ports 1538 can include connection ports, such as serial ports, parallel ports, or universal serial buses (USB). The interface ports 1538 can also accommodate output devices. For example, a USB port may be used to provide input to computer 1501 and to output information from computer 1501 to an output device. Output adapter 1539, such as video or sound cards, is provided to connect to some output devices such as monitors, speakers, and printers.

Computer 1501 can operate in a networked environment with remote computers. The remote computers, including a memory storage device, can be a data processing system, such as a personal computer, or a workstation, and typically includes many or all of the elements described relative to computer 1501. Remote computers can be connected to computer 1501 through a network interface 1535 and communication connection 1537, with wire or wireless connections. Network interface 1535 can be communication networks such as local-area networks (LAN), wide area networks (WAN) or wireless connection networks.

FIG. 15B shows a schematic block diagram of a sample computing environment with which the present invention can interact. The system 1500 includes a plurality of client systems 1541. The system 1500 also includes a plurality of servers 1543. The servers 1543 can be used to employ the present invention. The system 1500 includes a communication network 1545 to facilitate communications between the clients 1541 and the servers 1543. Client data storage 1542, connected to client system 1541, can store information locally. Similarly, the server 1543 can include server data storages 1544.

1. A computer-implemented method comprising
forming a travel policy for a company, wherein the travel policy comprises restrictions regarding travel related expenditures of multiple employees of the company;
receiving, from an employee of the multiple employees of the company, a search request for a travel reservation, wherein expenses of the travel reservation of the employee are governed by the travel policy of the company;
generating search results based on the search request for the travel reservation;
displaying the search results, wherein the displayed search results are annotated based on the travel policy;
analyzing selections of the employee from the search results to provide a degree of compliance with the travel policy;
reporting to the company regarding the selections of the user and the analysis of the selections; and
modifying the travel policy based on a feedback of the company or on the report to the company.

2. A method as in claim 1, wherein the travel reservation comprises at least one of a reservation for a flight, bus, or train itinerary, a reservation for a lodging accommodation, a reservation for a car rental, a reservation for a food order, or a reservation for an entertainment.

3. A method as in claim 1, wherein the displayed search results are arranged based on a preference profile of the employee.

4. A method as in claim 1, wherein all the search results are displayed, including search results not meeting requirements of the travel policy or search results restricted by the travel policy.

5. (canceled)

6. A method as in claim 1, wherein:
the travel policy comprises upper threshold limits, lower threshold limits, and warning ranges for the travel related expenditures,
expenses above the upper threshold limits require approval from the company,
expenses under the lower threshold limits are automatically approved,
expenses within the warning ranges require justifications from the employee, and
the upper threshold limits and the lower threshold limits are based on market conditions.

7. A method as in claim 1, wherein the annotation of the displayed search results comprises a notice of non-bookable together with a non-bookable reason, and an acceptance of a feedback from the employee.

8-9. (canceled)

10. A method as in claim 1, wherein the report to the company is configured to assist the company in updating the travel policy by setting limits of the travel expenditures to be conformed to market conditions.

11. A method as in claim 1, wherein the report to the company comprises current market values of the travel related expenditures to assist the company in modifying the travel policy.

12. A method as in claim 1, wherein the report to the company comprises justifications of the employee for the selections including warning notices.

13. A method as in claim 1, wherein the travel policy is modified to improve efficiency and cost effectiveness of the travel expenses.

14. A method as in claim 1, wherein the travel policy is modified to improve controls of the travel expenditures of the employee.

15. A method as in claim 1, wherein the travel policy is modified based on the selections of the user to improve satisfaction of the employee.

16. (canceled)

17. A method as in claim 1, further comprising:
upon receiving the selections indicating a non-compliance with the travel policy as indicated by the annotation, generating an intermediary graphical user interface rendered to accept a justification from the employee.

18. (canceled)

19. A computer-implemented method comprising:
forming a travel policy for an organization, wherein the travel policy comprises restrictions regarding travel related expenditures of multiple persons associated with the organization;
receiving, from a person of the multiple persons associated with the organization, a search request for a travel reservation, wherein expenses of the travel reservation of the person are governed by the travel policy of the organization;
generating search results based on the search request for the travel reservation;
displaying the search results, wherein the displayed search results are annotated based on the travel policy;
analyzing selections of the person from the search results to provide a degree of compliance with the travel policy through a machine learning process or an artificial intelligence (AI) algorithm;
reporting to the organization regarding the selections of the person and the analysis of the selections; and
modifying the travel policy based on a feedback of the organization or on the report to the organization.

20. (canceled)

21. A method as in claim 1, wherein the modified travel policy is applicable to the multiple employees of the company.

22. A method as in claim 1, wherein the report to the company occurs at a determined interval.

23. A method as in claim 1, wherein the report to the company is configured to assist the company in negotiating with preferred suppliers to update the travel policy.

24. A method as in claim 1, wherein the report to the company is configured to assist the company in regulating the travel expenditures by updating the travel policy.

25. A method as in claim 1, wherein the report to the company is configured to assist the company in updating the travel policy to improve satisfaction of the employee.

26. A method as in claim 1, wherein the annotation of the displayed search results comprises a notice of warning together with a reason for the warning notice, and a request for a justification from the employee.
